(19) United States
(12) Patent Application Publication
(10) Pub. No.: US 2008/0082027 A1
(43) Pub. Date: Apr. 3, 2008

(54) THERAPEUTIC DEVICE FOR INDUCING BLOOD PRESSURE MODULATION

(75) Inventor: Edward H. Phillips, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: RLE Corporation, Troy, MI (US)

(21) Appl. No.: 11/775,507

(22) Filed: Jul. 10, 2007

Related U.S. Application Data
(63) Continuation-in-part of application No. 11/749,505, now abandoned.
(60) Provisional application No. 60/848,740, filed on Oct. 2, 2006.

(51) Int. Cl. A61H 1/02

(52) U.S. Cl. 601/5; 601/24

(57) ABSTRACT

A therapeutic method and apparatus intended for enhancing blood circulation and neural fluid flow throughout a person's body. The person is placed supinely in a comfortable and relaxed state on a support member, such as a bed which is operated by a controllable motor driven drive mechanism. The support member tilts cyclically lice a seesaw to alternatively raise the person's upper torso and head about the lower extremities, and vice-versa.

### RELATED APPLICATIONS

The present application is a continuation-in-part of U.S. patent application Ser. No. 11/749,505 filed May 16, 2007 and entitled “Therapeutic Device for Inducing Blood Pressure Modulation” now abandoned, and claims priority of U.S. Provisional Patent Application Ser. No. 60/848,740 filed Oct. 2, 2006.

### BACKGROUND OF THE INVENTION

The present invention relates generally to therapeutic devices and, more particularly, to a therapeutic device and a method of use therefor that is believed herein to enhance blood circulation and neural fluid flow throughout a person's body.

Various types of devices have been used for enhancing blood flow through selected portions of human cardiovascular systems. This has been done for the purpose of alleviating various symptoms associated with different types of diseases or ailments. For example, enhanced external counter-pulsation (hereinafter “EECP”) utilizes pressure cuffs around various portions of a person's lower extremities and buttocks. The pressure cuffs sequentially and abruptly inflate and then deflate in sync with the person's heart rate such as to implement a reverse pulsation of blood flow back toward the person's upper torso and head immediately following systole. This results in pressure spikes of as much as 50 mmHg being imposed upon any partial arterial blockages that may be present in those portions of the person's body, and may in fact enable formation of collateral circulation passages around such partial blockages. In order to be effective, EECP is typically administered to a person over a series of 35 one-hour treatments during a seven-week period. During their abrupt inflation the pressure cuffs can often inflict significant discomfort in the person however, thereby causing him or her to be distressed and perhaps counteracting the therapeutic effect for which the device was intended. Furthermore, there has apparently been no suggestion that EECP is helpful in promoting enhancement of neural fluid flow within the human body.

Another device was described in a book entitled “Surgical Nursing” by Eliason, Ferguson and Farrand and published as early as 1929 by the J. B. Lippincott Company. It was called a “Sander's oscillating bed for treatment of peripheral vascular disease”. In describing the Sander's oscillating bed and its use tie authors stated the following:

“The Sander's oscillating bed is a method of administering passive exercises to allow intermittent filling and emptying of capillaries, venules and arterioles. The bed is set upon a rocker operated by a motor so that it tilts on its long axis at regular intervals. The intervals may be adjusted according to the needs of the patient and the wishes of the physician. This method of administering passive postural exercises may be carried out day and night and is claimed by some to have produced relief of the rest pain and of the pain associated with ulcers and gangrene. It may be used not only in arteriosclerosis and thrombo-angitis obliterans but also in minor degrees of arterial embolism.”

The Sander's oscillating bed was also described in the Aug. 4, 1951 issue of the Journal of the American Medical Association as being utilized at “high frequency” as a “vasoscillator”—thus implying that it was useful for dilating clogged blood vessels. It is believed herein that when it was utilized for this purpose, the Sander's oscillating bed was driven at a relatively high frequency significantly beyond 20 cycles per minute. On the other hand, other articles published during the 1950s detailed its use for augmenting ventilation in patients with poliomyelitis where it was driven at a “relatively low frequency” of perhaps 20 cycles per minute that was considered to be compatible with a normal rate of breathing.

As will be fully explained hereinbelow, it is believed herein that operation of such a bed at the high frequencies noted above would be grossly inappropriate. First of all, it would most likely induce discomfort in the patient. But of more significance herein, there most likely would be insufficient time to substantially drain pooled venous blood from selected portions of a person's venous system during the portion of each cycle when they are subject to pressure values lower than atmospheric pressure, or later during the cycle, to totally fill the veins comprised in those portions of the person's venous system with new venous blood coming from associated arterioles, capillaries and venules—when otherwise those veins would have dilated and become subject to pressure values greater than atmospheric pressure. Thus, implementation of even the basic concept of blood pressure modulation as explained below would not be possible on a Sander's oscillating bed operated the high frequencies noted above.

Further, it is also believed herein that all versions of the Sander's oscillating bed were implemented with a flat (e.g., planar) bed and, as implied above, “set upon a rocker operated by a motor so that it tilts on its long axis at regular intervals”. Because of such construction, it is also believed herein that shoulder and foot constraints were typically utilized for longitudinally restraining patients so that they wouldn't slide “up or down” excessively. It is believed herein that use of such artificial shoulder and foot constraints would also tend to induce discomfort in the patient. Perhaps because of the requirement for such artificial constraints, or because of the above explained high frequency misapplication in its use, or even simple patient discomfort associated with the high frequency operation, or because of safety concerns relating to the open rocker construction, the Sander's oscillating bed obviously fell out of favor.

On the other hand, described in detail in U.S. Pat. No. 6,261,250 is an alternate type of therapeutic device that includes a bench or support member upon which a person can lie down. Harnesses are attached to each arm and leg of the person. The harnesses are attached to cables actuated by a gearmotor in a manner that cyclically and synchronously raises and lowers all of the person's limbs. The change in elevation of the person's limbs causes a moderate modulation of blood pressure in both of the arterial and venous networks of the person's cardiovascular system. This therapeutic device is believed to be effective in enhancing blood flow throughout the person's circulatory system, including his or her coronary system as well as in his or her brain. In addition, it is also believed to be effective in enhancing neural fluid flow within the person's body generally, and particularly in tie brain. However, it does require an amount of coordinated muscle activity on the person's part to properly position him- or her-self on the bench and to maintain his or her limbs within the harnesses, as well as to properly interact with the device. For some people, such interactions can be stressful and could even somewhat counteract the therapeutic effect for which the device is intended. Furthermore, the therapeutic device depicted in the '250 patent comprises an open counter-balanced flywheel that for safety reasons would obviously be of concern.

It is important to understand that utilization of any of these example therapeutic devices does not impose a medically oriented treatment upon a person similarly to that such as he or she would typically experience via utilizing invasive types of treatment provided by a medically licensed physician through his or her prescription of medication, or by execution of a surgical procedure. Rather, their use is generally non-invasive in nature, and with the exception of EECP, any person could use them in a self-operated manner at his or her own volition. Alternately of course, such self-operated apparatus could also be utilized with the assistance of an alternative medicine practitioner, or even at the suggestion of a medically licensed physician. Their use by any person can most accurately be described as that of non-invasively conditioning that person in a manner essentially similar to him or her exercising on exercise apparatus in a gym, so that his or her body could be enabled for improving, or even possibly for curing, itself.

It is believed herein that the human body is capable of achieving amazing self-curative powers. Thus it is also believed herein that an improved therapeutic device and an improved method for use thereof intended for enhancing blood and neural fluid flow throughout the human circulatory system and brain without inducing unacceptable levels of stress and/or discomfort are needed.

### SUMMARY OF THE INVENTION

The present invention relates to an improved therapeutic method and self-operated apparatus intended for enhancing blood and neural fluid flow in a person's body and brain. The person places him- or her-self in a supine position on a support member, such as a bed or table formed in a contoured manner whereby the person can comfortably be retained thereupon without artificial constraints. The support member is then cyclically rocked or tilted in a seesaw manner so that the person is tilted from an upper torso and head-elevated position to a lower extremities-elevated position. Generally, it has been anecdotally observed that desired therapeutic blood and neural fluid flow enhancing effects are optimized when the person assumes a mentally relaxed state, and optimally so, when he or she is able to fall into a sleep state during operation of the apparatus. Further, because the person's dominant weight supporting points are continually moving between different areas of his or her buttocks and lower torso as a function of instant tilt angles obtained during the rocking motion, it has been anecdotally observed that the phenomenon of forming bed sores is highly unlikely or even impossible, irregardless of how long the person remains on the rocking apparatus.

A drive mechanism is used to cyclically move the support member in a seesaw manner in order to elevate the person's upper torso and head above his or her lower extremities, and then to elevate the person's lower extremities above his or her upper torso and head. The cyclical rate of motion can range between 2 to 10 cycles per minute and is preferably about 6 cycles per minute. The total angular range of motion of the support member relative to its nominally centered horizontal position can range between 10° and 60° and is preferably around 30°.

Again, it should be emphasized that utilization of the therapeutic method and self-operated apparatus does not impose a medically oriented treatment upon a person similarly to that such as he or she would typically experience via utilizing invasive types of treatment provided by a medically licensed physician through his or her prescription of medication, or by executing a surgical procedure. Rather, its use is generally non-invasive in nature and can be used by any person at his or her own volition. Alternately of course, it can be utilized with the assistance of an alternative medicine practitioner, or even at the suggestion of a medically licensed physician. In fact, its use by any person can more accurately be described as that of non-invasively conditioning that person via an internal massaging of his or her tissues through rhythmic shrinking and swelling of appropriate portions of his or her venous system, so that his or her body can be enabled for improving, or even possibly for curing, itself.

Other benefits, features and aspects of the present invention will become apparent from a review of the following description of preferred embodiments, when viewed in accordance with the attached drawings and appended claims.

### BRIEF DESCRIPTION OF THE DRAWINGS

FIG. 1 schematically illustrates a method intended for enhancing blood and neural fluid flows in a human body and brain in accordance with the present invention.

FIGS. 2A, 2B and 2C are side views illustrating the range of motion of an example therapeutic device utilized for practicing the example method of FIG. 1.

FIG. 3 is a side view depicting the example therapeutic device shown in FIGS. 2A, 2B and 2C in greater detail.

FIG. 4 schematically illustrates a method of controlling a therapeutic device comprising a servo drive mechanism but otherwise similar in function to that shown in FIG. 3.

FIG. 5 is a perspective view of an example drive mechanism for cyclically moving the therapeutic device shown in FIG. 3.

### DETAILED DESCRIPTION OF THE PREFERRED EMBODIMENTS

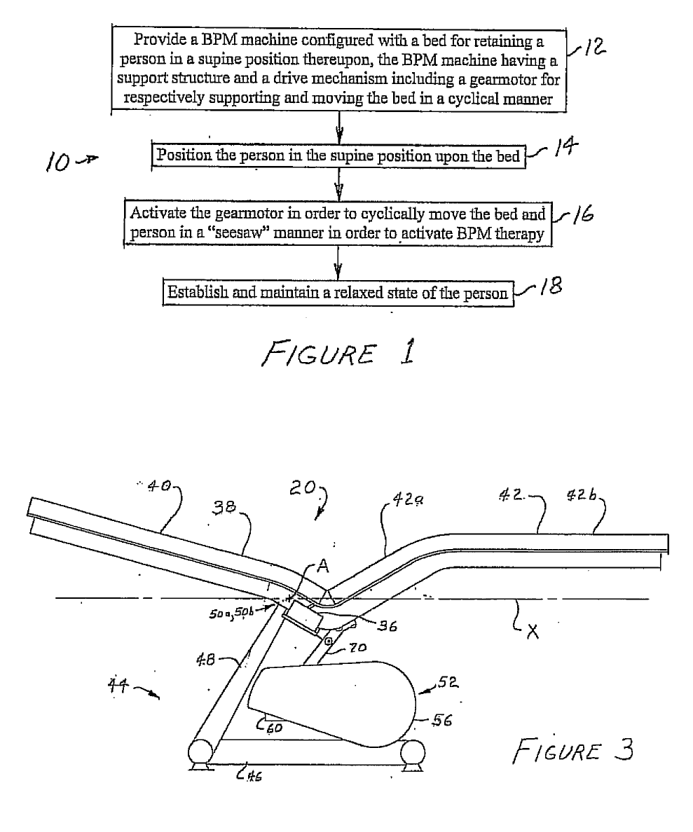

FIG. 1 illustrates an improved example method 10 of inducing Blood Pressure Modulation therapy (hereinafter “BPM therapy”) on a blood pressure modulation machine (hereinafter “BPM machine”), which BPM therapy is believed herein to enable enhancement of blood and neural fluid flows through the human circulatory system and brain. In some examples, the method 10 has been anecdotally observed to be therapeutically helpful for enabling an improved quality of life for persons having various types of physical and neural diseases or ailments such as heart or other forms of cardiovascular disease, Parkinson's disease, Alzheimer's disease, multiple sclerosis, essential tremor, muscular dystrophy, autism, migraine headaches, brain injuries, or diabetic circulation problems (i.e., open wounds), etc.

A first step 12 of the example method 10 includes providing the BPM machine, which BPM machine comprises a generally horizontal and preferably contoured support member (hereinafter referred to as a “bed”) configured for retaining a person in a supine position thereupon generally along a longitudinal axis such that his or her upper torso and head are longitudinally spaced apart from his or her lower extremities. The BPM machine also comprises necessary support structure as well as a gearmotor and drive mechanism for pivotally supporting and moving the bed in a cyclical manner to be described in detail hereinbelow. A second step 14 includes positioning the person on the bed so that he or she lies supinely thereupon with his or her upper torso and head, and lower extremities spaced apart generally along the longitudinal axis.

A third step 16 includes activating the gearmotor for the purpose of cyclically moving or tilting the bed, and of course the person, in a “seesaw” manner in order to activate BPM therapy. This causes the person's upper torso and head to be elevated above his or her lower extremities, and then the person's lower extremities to be elevated above his or her upper torso and head, and vice-versa. In one example, the total angular range of motion (hereinafter “angular range”) of the support member relative to its nominally centered horizontal position can range between 10° and 60° and is preferably around 30°. As described in detail below, this procedure modulates blood pressure in both of the arterial and venous networks of the cardiovascular system. It is believed herein that resultant switching of venous blood pressure between positive and negative values and back again with respect to atmospheric pressure (hereinafter “venous blood pressure switching events”) during each cycle of blood pressure modulation is principally responsible for enhancement of blood and neural fluid flows within the human body and brain, which enhancement of blood and neural fluid flows is believed herein to account for the above-mentioned anecdotally observed improved quality of life for persons having various types of physical and neural diseases or ailments such as heart or other forms of cardiovascular disease, Parkinson's disease, Alzheimer's disease, multiple sclerosis, essential tremor, muscular dystrophy, autism, migraine headaches, brain injuries, or diabetic circulation problems (i.e., open wounds), etc.

Utilizing lesser angular ranges than the preferred 30° would of course result in a reduced modulation of blood pressure. Although it is believed herein that this would also be effective in enhancing blood and neural fluid flows within the human body and brain, it might materially compromise the desired venous blood pressure switching function over significant potions of the body. Thus, achieving an equivalent improvement therein could require extended treatment times and/or an extended series of treatments.

On the other hand, utilizing greater angular ranges than the preferred 30° would result in increased modulation of blood pressure. But this might require the person to be strapped or “velcroed” to the bed, in order to preclude him or her from sliding either upwards or downwards and would almost certainly be required in cases wherein a selected angular range of motion resulted in the person's torso assuming even a relatively modest negative angular attitude whenever the bed approached its extreme lower extremities-elevated position. In any case, it has been anecdotally observed that the preferred 30° angular range is quite sufficient for achieving desired therapeutic results. Furthermore, greater angular ranges might require the cyclical rate of alternate elevation of the person's upper torso and head, and lower extremities (hereinafter “cyclical rate”) to be reduced in order to maintain a comfortable and relaxed state of the person. This of course would reduce the number of venous blood pressure switching events, and thus could even be counterproductive.

The fourth step 18 of the example method 10 includes establishing and maintaining a comfortable and relaxed state of the person. In a preferred example, such a comfortable and relaxed state corresponds to establishing a sleep state of the person while he or she is experiencing BPM therapy. In another example, the comfortable and relaxed state corresponds to a relatively low blood pressure state of the person, such as at or even below an “at rest” blood pressure determined according the person's age, weight, height, or other factors. In yet another example, the comfortable and relaxed state corresponds to the heart rate of the person, such as an “at rest” heart rate determined according the person's age, weight, height, or other factors. Factors involved in establishing and maintaining the comfortable and relaxed state of the person include: locating the BPM machine in a relatively isolated and quite environment; avoiding any contact with the person (i.e., such as talking to him or her) during his or her treatment period with the purpose of inducing him or her into a sleep state; and/or failing that, engaging in quiet and relaxing conversation with the person for the purpose of calming him or her if he or she exhibits hyperactivity, hypersensitivity or hyperirritability symptoms.

Again, properly selecting the cyclical rate of alternate elevation of the person's lower extremities, and upper torso and head (hereinafter “cyclical rate”) is also important in establishing and maintaining the comfortable and relaxed state of the person. The combination of angular range and cyclical rate is chosen such as to preclude dizziness or other discomforts in the person and is a definite factor in inducing a comfortable and relaxed state conducive to the person attaining a state of sleep. In general, it has been found through anecdotal observation that the combination of angular range and cyclical rate should be chosen such that their product is between 90° cycles/minute and 360° cycles/minute. Thus in a further preferred example, the cyclical rate is set at an average 180° cycles/minute divided by the above-suggested angular range of 30° or at a preferred cyclical rate of six cycles per minute. This preferred combination of an angular range of 30° and a cyclical rate of six cycles per minute has been anecdotally observed to provide the above noted improvements in quality of life without inducing discomfort. Other combinations chosen from within the above mentioned angular ranges of 10° and 60°, and cyclical rates between two to ten cycles per minute could certainly be acceptable however.

Prior to beginning any treatment using the present invention, a preliminary workup comprising noting a person's vital statistics and perhaps performing any pertinent neurological testing could be done in order to establish a baseline status for that person as of the start of that particular treatment session. One might note a person's age, blood pressure, heart or neurological disease history for instance. In addition, special precautions should be taken in the case of a brain injured person or perhaps for one having Alzheimer's disease. Further, it would be desirable to do a comparative post treatment workup as well in order to record any changes related to the person having experienced BPM therapy during that session. And still further, it would be desirable compile each person's workup documentation in order to establish that person's progress over time.

The cardio-pulmonary portion of the human circulatory system includes the right side of the heart receiving oxygen-depleted blood from a person's venous system and pumping it through the lungs, wherein carbon dioxide is exchanged for oxygen, and then on to the left side of the heart from where the now oxygen-rich blood is pumped into the arterial network. The arterial network comprises arteries and arterioles that convey the oxygen-rich blood from the heart to an extraordinary multitude of capillaries. The arteries include a layer of smooth muscle cells that serve to maintain arterial blood pressure between systolic events. Similar layers of smooth muscle cells included in the arterioles are utilized by the person's brain for selectively controlling the size of the arterioles. In addition, each capillary is protected by a pre-capillary sphincter, which sphincters are utilized by the person's brain for selectively controlling proportions of capillaries open to blood flow in the person's body. These factors permit the person's brain to regulate blood flow throughout his or her cardiovascular system in addition to controlling instant blood pressure values and selectively servicing minor trauma such as a cut or scrape. In any case, the blood flows through the open ones of the capillaries, wherein the oxygen is exchanged for carbon dioxide, and then on to the venous system.

The venous system includes veins and venules that convey the now oxygen-depleted blood from the capillaries back to the vena cavas (e.g., the two large veins that enter into and return venous blood to the right atrium of the heart) and therethrough to the heart. Although the larger veins comprise semi-lunar folds that act like one-way check valves precluding flow in a reverse direction back toward the capillaries, generally the veins and venules of the venous network are simpler and more compliant than the arteries and arterioles. However, they also include layers of smooth muscle cells. These layers of smooth muscle cells are utilized by the person's cardiovascular control center for regulating the circumferential size of the veins themselves. In actuality this involves the person's brain and body continuously executing very complex and precise servo control of the volumetric size of the venous system. This complex function is implemented in accordance with a fairly long time constant however—lasting perhaps tens of seconds and definitely longer than a single cycle of operation of the BPM machine. In any case, the veins act as an active blood reservoir that contains about 65% of the body's total blood volume—with the size of the veins and thus the volume of the reservoir being controlled in apparent response to signals emanating from a cardiopulmonary mechanoreceptor located in the right atrium of the heart—such that average venous blood pressure in the extreme upper torso (i.e., normally a few inches below shoulder height when a person is disposed in an upright manner) is maintained at atmospheric pressure (hereinafter the “zero pressure point”).

As a result, venous blood pressure present at any particular point within a person's venous system can be determined by the formula

P=1.875 h

where P is the difference between venous blood pressure at that particular point and atmospheric pressure (in mmHg), and h is the vertical distance between that particular point and the vertical position of his or her zero pressure point (in inches). Thus, portions of the venous system that are instantly positioned vertically below the zero pressure point have positive pressure while portions of the venous system that are instantly positioned vertically above the zero pressure point have negative pressure (e.g., in each case relative to atmospheric or zero pressure). This means that there is a positive differential pressure value imposed between the outside of those portions of the person's body that are vertically positioned above the instant zero pressure point and the veins comprised therein. This compresses those veins and causes “pooled” venous blood contained therein to “drain” back toward his or her vena cavas (e.g., with the venous blood freely moving through the above described check valves) with the result that those veins are compressed or even flattened out.

On the other hand, there is a positive differential pressure value imposed between veins comprised within those portions of the person's body vertically positioned below the instant zero pressure point and the outside of those body portions. This allows those veins to fill (i.e., from blood flowing thereto from juxtaposed arterioles, capillaries and venules—and not back down through the larger veins themselves because of the one-way flow nature of the check valves) and expand. In either of these cases, it is believed herein that it is necessary to provide adequate time for allowing these “draining and filling” functions to fully occur. Thus the hereinabove described relatively slow preferred cyclic rate of 6 cycles per minute is, for this reason, herein deemed to be appropriate. In any case, it is believed herein that tissue comprised within portions of the person's body that undergo vertical transitions above and then below the zero pressure point is continually internally massaged by the rhythmic compression and expansion of its comprised veins. This is the essence of blood pressure modulation.

This general principle can be demonstrated by observing what happens to a visible peripheral vein running along the back of one's hand and arm as that hand and arm are slowly raised toward shoulder height. Portions of that vein will begin to flatten out as they reach a few inches below shoulder height and remain flattened while they are above that height. In fact, as one slowly raises the hand and arm he or she may even feel the progression of this flattening as different portions of the vein suffer a transition from positive to negative pressure. As next explained, it is believed herein that substantially the same action occurs within the upper torso and head, and also within the lower extremities of a person whenever he or she is supinely disposed upon a cyclically moving BPM machine.

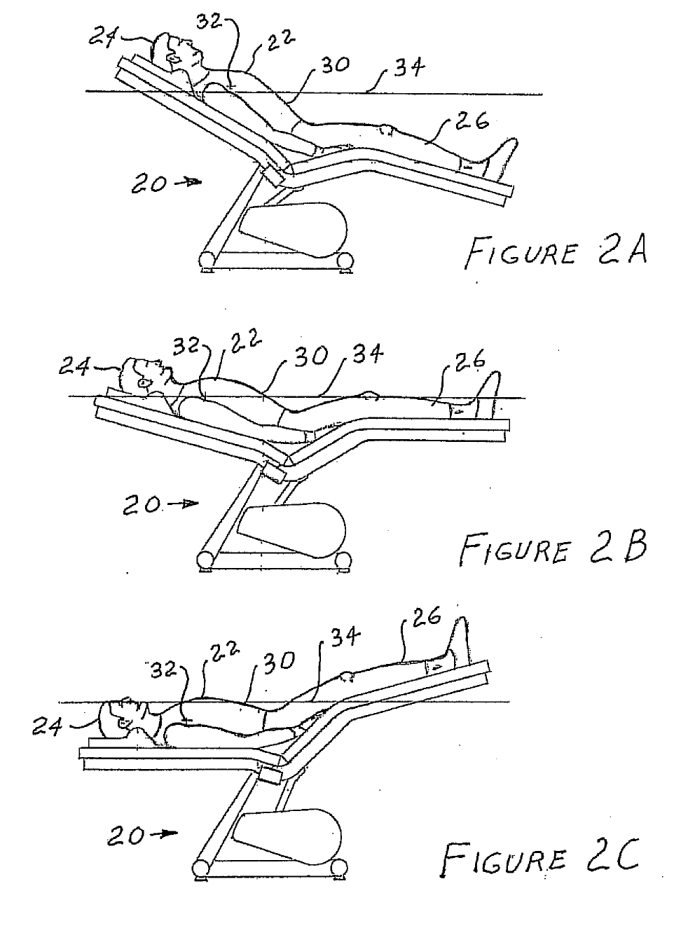

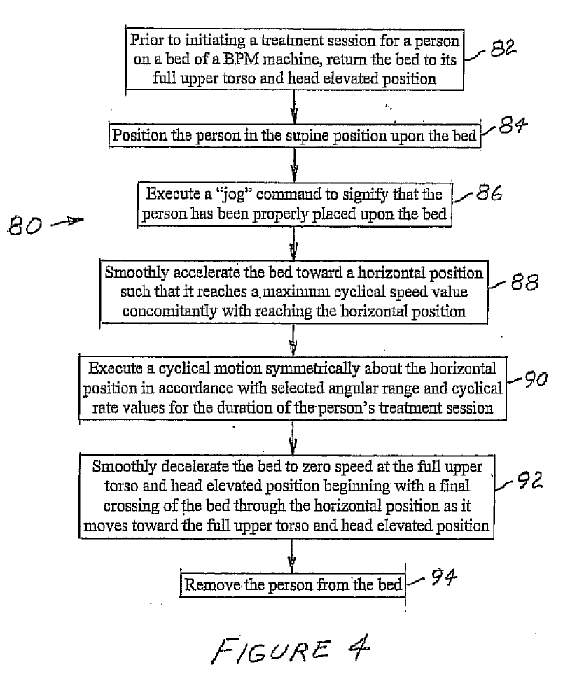

In accordance with the above explained functioning of the venous system, utilizing a BPM machine for cyclically enabling alternate elevation of a person's upper torso and head, and then his or her lower extremities results in tie venous blood pressure in the upper torso and head first falling below and then rising above atmospheric pressure, and vice-versa in the lower extremities. These variations of venous blood pressure in a person 30 disposed on a BPM machine 20 are illustrated in FIGS. 2A, 2B and 2C wherein FIG. 2A depicts the portion of the cycle of its operation whereat the person 30's upper torso 22 and head 24 are elevated; FIG. 2B depicts either portion of the cycle whereat it and the person 30 are disposed in a nominally centered horizontal position (hereinafter “horizontal position”); and FIG. 2C depicts the portion of the cycle whereat the person 30's lower extremities 26 are elevated, Of these, the horizontal position depicted in FIG. 2B can logically be said to approximate the average disposition of the person 30 while he or she is disposed upon the cyclically moving BPM machine 20. Thus the above described zero pressure point 32 is comprised in a zero pressure line 34 passing through its upper central location in the upper torso 22 as the BPM machine 20 and person 30 are disposed in the horizontal position as depicted in FIG. 2B. This defines the fractions of the venous system that are subject to positive and negative pressure values regardless of instant angular dispositions of the cyclically moving BPM machine 20 because of the above noted inability of the venous volumetric control system to quickly respond. This results in the positions of the zero pressure line 34 depicted in FIGS. 2A and 2C wherein the person 30's upper torso 22 and head 24 are depicted as being subject to alternating negative and then positive pressure values, and his or her lower extremities 26 are concomitantly subject to alternating positive and then negative pressure values.

Assuming that a combination comprising the preferred angular range and cyclical rate values of 30° and six cycles per minute is chosen, gravitational forces resulting from cyclical alternate elevation of the person 30's upper torso 22 and head 24, and then lower extremities 26 in accordance with the example method 10 rhythmically modulate the venous blood pressure in the upper torso 22 and head 24, and also of course the lower extremities 26, over a range of perhaps 20-30 mmHg. Thus, when the upper torso 22 and head 24, and alternately the lower extremities 26, attain peak elevation above the zero pressure line 34 as respectively depicted in FIGS. 2A and 2C, venous blood pressure in those portions of the person 30's body is lowered below atmospheric pressure by up to 15 mmHg. Because the arterial blood pressure in those portions of the person 30's body is nominally lowered by the same amount, the pressure drop across the comprised arterioles, capillaries and venules substantially remains the same. Thus the returning blood flow approximately remains the same. But there is now a pressure differential up to 15 mmHg between atmospheric pressure externally impressed upon the person 30's body and the venous blood pressure within those portions of the his or her body. As explained above, this pressure imbalance enables the surrounding tissue to somewhat compress or shrink those portions of the venous system. This forces venous blood out of those veins generally toward the vena cavas (again, this phenomenon is responsible for the observed flattening of peripheral veins in a person's hand and forearm as he or she raises that arm as well as the general feeling that blood is “draining” down from that arm as and after it is elevated).

On the other hand, as the upper torso 22 and head 24, or alternately, the lower extremities 26 are lowered as respectively depicted in FIGS. 2C and 2A, the venous blood pressure in those portions of the person 30's body switches from a negatively valued pressure to a positively valued pressure of up to perhaps 10 mmHg in the head and 20 mmHg in the lower extremities, Thus as those previously compressed portions of the venous system have had time to “fill up” with new blood emanating from juxtaposed arterioles, capillaries and venules, a progressively moving venous blood pressure switching event results wherein a similar but opposite differential pressure difference between venous blood pressure and atmospheric pressure occurs. This causes the veins to swell because the returning blood from those arterioles, capillaries and venules tends to “pool” as it expands the smooth muscle tissue of those veins (i.e., this phenomenon is responsible for tie feet swelling during a prolonged airplane trip).

In either case, each venous blood pressure switching event causes an oppositely oriented three-dimensional pressure gradient to be formed across the tissue between the skin and the venous network of veins and fine veins in those portions of the person 30's body. As explained above, it is believed herein that the cyclical shrinking and swelling of the veins comprised within that tissue (e.g., occurring as a direct result of the venous blood pressure switching events) results in a cumulative internal massaging of juxtaposed tissue. It is further believed herein that this can result in opening up other juxtaposed fluid flow channels. This may be due to breaking down plaque deposits in the manner suggested below, or by straightening out flattened and twisted fluid flow channels (e.g., commonly associated with Alzheimer's and perhaps various other neural diseases). In particular, the internal massaging is believed herein to enable opening of neural fluid flow channels, as well as enhancing blood flow, in the brain. By way of example, before and after sets of MM studies have demonstrated that utilization of BPM therapy resulted in a significant reduction of scar tissue with an associated increase of blood flow and density in the brain of a brain injured person in one recent example case.

In addition to the above described possible opening up of fine arteries, arterioles, capillaries, venules, and neural channels, it is believed herein that similarly induced internal massaging of tissue juxtaposed to partially blocked portions of coronary arteries may induce comprised capillaries to extend, link up and form collateral bypass flow channels or passages around partially blocked portions of the coronary arteries. This is thought to be the primary operative mechanism behind observed alleviation of angina symptoms achieved through utilization of BPM therapy by persons suffering from heart disease.

It is further believed herein that cyclical internal messaging of tissue surrounding cyclically shrinking and swelling veins can also physically manipulate protein and metallic based plaque deposits and/or floating plaque particles present within arteries in such a manner as to encourage the plaque deposits and/or floating particles to break down into smaller and smaller particles. Then, and especially in conjunction with the use of chelator and bile enhancing supplements, it is believed that the plaque particles progressively dissolve, or at least disintegrate into micro-particles small enough to pass through the capillaries and into the venules and veins, and eventually on to the person's liver and/or kidneys where they can be eliminated naturally. This is thought to be the primary operative mechanism behind an apparent “cleansing function” whereby protein and/or metallic-based plaques in the circulatory system have been observed to be progressively eliminated over a succession of one or more treatment sessions to alleviate symptoms associated with the plaque deposits.

The extent of similar action on any plaque deposits trapped between tunica intima and tunica media tissue layers of the juxtaposed arteries is not known at this time. However, it has been anecdotally observed that should such trapped plaque deposits rupture through the tunica intima layer of tissue, the above described internal messaging of surrounding tissue can provide adequate blood flow for supporting heart function without an infarction occurring. In each of the anecdotally observed cases, chelator and bile enhancing supplements were utilized to attack the plaque and any possible clot formations resulting therefrom, with the clearing process typically taking about four days.

In the example method 10, it is believed herein that the step of establishing the comfortable and relaxed state of the person further enhances the operative mechanisms described above. Otherwise whenever he or she might be under stress from discomfort or even when actively engaged in conversation, the smooth muscle cells associated with the veins and venules could tend to activate and thus resist the desired swelling and collapsing action.

Reduction of medication dosages, or in some cases even total elimination thereof has been anecdotally observed to be a further benefit for persons utilizing the example method 10. By way of example, persons having Parkinson's disease normally use prescribed dosages of various medications in order to minimize their Parkinson's disease symptoms. In conjunction with using the example method 10 however, such normally prescribed dosages have been anecdotally observed to induce overdose symptoms in some persons having Parkinson's disease (i.e., such as uncontrolled and wildly gyrating arm and leg motions). Herein this is regarded as evidence that the method 10 does indeed improve natural neural fluid flow (i.e., such as in this case perhaps being a renewed flow of naturally generated dopamine). Therefore, an additional benefit of using the example method 10 may be that such medication dosages can be reduced, or in some cases even eliminated.

FIG. 3 is a side view of an example therapeutic device 20 for conducting the example method 10. In this example, the therapeutic device 20 includes a bed 38 here shown in the horizontal position. The bed 38 is configured with a torso and head-supporting portion 40, and a lower extremity-supporting portion 42 spaced generally along a horizontally disposed longitudinal axis “X”. The lower extremity-supporting portion 42 is in turn configured with a thigh-supporting portion 42a and a calf and foot-supporting portion 42b. The torso and head-supporting portion 40 is preferably angled upwards with reference to the horizontally disposed longitudinal axis “X” at an angle approximately equal to half of the selected angular range while the thigh-supporting portion 42a is preferably oppositely angled upwards at an angle approximately equal to the selected angular range, and the calf and foot-supporting portion 42b is preferably disposed in a plane nominally parallel to the longitudinal axis “X”.

The bed 38 is pivotally mounted to a frame 44. The frame 44 includes a base section 46 that supports an angled section 48. In this example, the angled section 48 includes pivots 50a and 50b that pivotally connect to a portion of the bed 38 (FIG. 5). The pivots 50a and 50b define a pivot axis “A” that is oriented in a transverse manner with respect to a vertical plane (not shown) that comprises the longitudinal axis “X”. Finally, a drive mechanism 52 is utilized for rotatably moving the bed 38 in a cyclical manner about the pivot axis “A” in accordance with selected angular range and cyclical rate values, whereby the longitudinal axis X is then operative for defining instant rotational orientations of the bed 38 around the pivot axis A (i.e., between the extreme positions depicted in FIGS. 2A and 2C).

Co-pending U.S. patent application Ser. No. 11/209,813 depicts a Scotch yoke drive assembly 96, a crank and connecting rod mechanism 188, a servo controlled rack and pinion gear set 194, and a servo controlled hydraulic drive 196, any of which would be suitable for cyclically moving the bed 38. Because of its obvious relevance to the present invention, U.S. patent application Ser. No. 11/209,813 (hereinafter “application '813”) is expressly incorporated herein by reference. Because of the descriptive presentations of the Scotch yoke drive assembly 96, the servo controlled rack and pinion gear set 194, and the servo controlled hydraulic drive 196 made in incorporated application '813, no further description relating to any of these types of drive mechanisms is required herein. On the other hand, the example therapeutic device 20 does utilize the simplified example crank and connecting rod mechanism 54. Thus, its construction and operation is described hereinbelow with reference to FIG. 5.

Either of the Scotch yoke drive assembly 96 shown in FIGS. 8A-C of application '813, or crank and connecting rod mechanism 188 shown in FIGS. 9 and 11 of application '813 can be controlled by a simple switch such as switch 36 depicted in FIG. 3 of the present application. In the case of the incorporated application '813 such a switch would be operative to activate and deactivate a gearmotor 98 depicted in each of FIGS. 8A-C, 9 and 11 thereof. On the other hand, either of the servo controlled rack and pinion gear set 194, or the servo controlled hydraulic drive 196 (i.e., comprising a servomotor driven pump and a hydraulic cylinder), respectively shown in FIGS. 12 and 13 of the incorporated application '813, could be utilized for achieving selected combinations of angular motion and cyclical rate as deemed suitable for individual persons. In either case, a controller 130 also shown and described in the incorporated application '813 could be used for commanding appropriately selected angular range and cyclical rate values, or even for programming varying values of angular ranges and cyclical rates during treatment sessions.

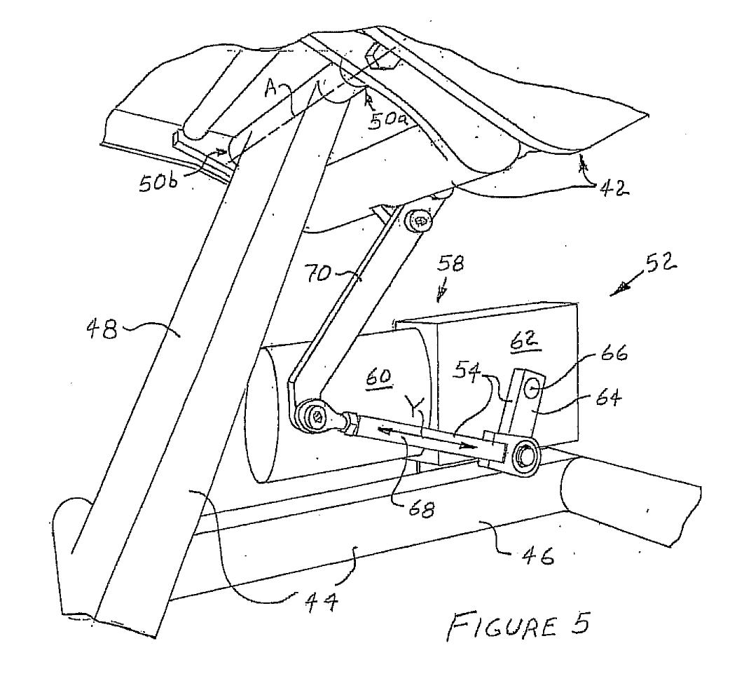

FIG. 4 of the present application illustrates an example method 80 for optimally controlling a therapeutic device 20 driven by either of the servo controlled rack and pinion gear set 194, or the servo controlled hydraulic drive 196 of the incorporated application '813. Such optimal control can be obtained through programming controller 130 of the incorporated application '813 for operation over a treatment session for a particular person including selected angular range and cyclical rate values in accordance with the following steps:

The first step 82 of the example method 80 is executed prior to initiating a treatment session for a person 30 on the bed 38 and includes returning the bed 38 to its full upper torso and head-elevated position in order to provide a preferred entry/exit position of the bed 38. A second step 84 includes positioning the person 30 in a supine position upon the bed. A third step 86 includes either the person 30 or a therapist executing a “jog” command signifying that the person 30 has been properly placed on the bed 38, and enabling the program to continue. A fourth step 88 includes smoothly accelerating the bed 38 toward the horizontal position such that it reaches a maximum cyclical speed value concomitantly with reaching the horizontal position. A fifth step 90 includes executing a cyclical motion symmetrically about the horizontal position in accordance with the selected angular range and cyclical rate values for the duration of the treatment session. A sixth step 92 includes smoothly decelerating the bed 38 to zero speed at its preferred full upper torso and head-elevated entry/exit position, beginning with a final crossing of the bed 38 through the horizontal position as it moves toward the upper torso and head-elevated position. And finally, a seventh step 94 includes removing the person 30 from the bed 38 in order to terminate the treatment session. Given this description, one of ordinary skill in the art will recognize and be able to generate command sequences for obtaining suitable combinations of acceleration/deceleration characteristics, other treatment angular range and cyclical rate values, or varying values of angular ranges and cyclical rates during treatment sessions in order to meet the needs of particular persons.

Shown in FIG. 5, is a perspective view of the example crank and connecting rod drive mechanism 54 with a cover 56 shown in FIG. 3 removed. In this example, the drive mechanism 52 includes a gearmotor 58 comprising a motor 60 and a speed-reducing gearbox 62 driving a crank 64 via an output shaft 66 of the speed-reducing gearbox 62. The crank 64 engages a connecting rod 68 that is pivotally connected to a drive arm 70 that extends from the bed 38. In this case the switch 36 is operative to activate and deactivate the motor 60 and thus the drive mechanism 52. It is true that the drive mechanism 52 is capable of only providing a single valued angular range. However, it does have the advantage of including readily available components such as the gearmotor 58 and switch 36. Therefore, it follows that a therapeutic device 20 comprising the example drive mechanism 52 can be quickly and economically developed, and may in fact, be more economical to produce. This could be important because it would be desirable to produce therapeutic devices 20 in large volumes for home use by persons having various types of disease or ailment conditions such as heart or other forms of cardiovascular disease, Parkinson's disease, Alzheimer's disease, multiple sclerosis, essential tremor, muscular dystrophy, autism, migraine headaches, brain injuries, or diabetic circulation problems, etc. as mentioned above.

Surprisingly, there is also an advantage in not utilizing a controller such as the controller 130 shown and described in incorporated application '813. This is because such controllers typically utilize a bridge circuit comprising solid state switching devices that are usually relatively unshielded and therefore a source of high frequency electromagnetic radiation considered undesirable by a large percentage of potential users of the example therapeutic device 20. In fact, such high frequency electromagnetic radiation could conceivably be dangerous for individuals using pacemakers. Thus, utilization of the drive mechanism 52 as controlled by the simple switch 36 in example therapeutic device 20 is considered herein to be preferable.

In the example drive mechanism 52 the gearmotor 58 serves to rotate the crank 64. Rotation of the crank 64 cyclically moves the connecting rod 68 back and forth along an undulating thrust axis “Y” in order to position and exert necessary forces on the drive arm 70 as required for it to cyclically move the bed 38 rotatably in a seesawing manner about the pivot axis “A”. The resulting cyclical motion of the bed 38 alternately elevates the upper torso and head, and then the lower extremities of a person lying on the bed 38 in the cyclical manner described hereinbefore. As can be appreciated, the length of the crank 64 can either be designed for a larger or smaller stroke of the drive arm 70 and resulting angular range values, or even be configured in the manner of adjustable length crank arm 100 of application '813 in order to attain selected angular range values. Given these descriptions, one of ordinary skill in the art will recognize several variations in providing suitable drive mechanisms and drive modes for cyclically moving the bed 38.

Although preferred embodiments of this invention have been disclosed, workers of ordinary skill in the various arts associated with this invention would recognize that certain modifications would come within the scope of this invention. For instance, BPM therapy could be utilized for treating other diseases or conditions not named above, or alternately, the cyclic elevation step 16 of method 10 could be executed in a more complex fashion not described in detail above (i.e., such as comprising a programmed range of cyclical rates and/or angular ranges). Also, the construction details of the therapeutic device 20 could be altered without deviating from the spirit of this invention. By way of example, a modified bed 38′ could comprise independent torso and head, and lower extremity supporting portions capable of pivoting or rotating relative to each other. These could for instance, be utilized for altering the contoured shape of the bed 38. In another example, the speed-reducing gearbox 62 could be replaced by the combination of a hydraulic pump and hydraulic motor whose output shaft would then be utilized for driving the crank 64. For that reason, the following claims should be studied to determine the true scope and content of this invention.

1. A method for therapeutic treatment of a disease or ailment condition through the use of blood pressure modulation (BPM) therapy, said method comprising the steps of:
providing a BPM apparatus comprising:
a bed configured to retain a person thereupon in a supine manner generally along a longitudinal axis such that said person's upper torso and head are longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said BPM apparatus further including a motor; and
a drive mechanism for selectively coupling to said motor to said bed;
wherein said motor is energizable for rotatably and cyclically moving said bed about said pivot axis;
disposing a person on said bed so that said person lies supinely thereupon with his or her upper torso and head, and lower extremities spaced apart generally along said longitudinal axis; and
energizing said motor so as to activate said BPM apparatus and thereby rotatably move said bed about said pivot axis through at least one cycle wherein said person's lower extremities are raised to a level higher than said person's upper torso and head, and vice-versa;
wherein said at least one cycle causes a modulation of the person's venous blood pressure wherein resulting venous blood pressure switching events cause shrinking and swelling of the veins of the person's upper torso and head, and concomitantly, swelling and shrinking of the veins of the person's lower extremities.

2. The method as set forth in claim 1, wherein said at least one cycle is in reality many cycles and the associated multiple venous blood pressure switching events may result in cumulative internal massaging and opening up of other fluid flow channels in the person's upper torso and head, and/or lower extremities.

3. The method as set forth in claim 2, wherein said other fluid flow channels comprise arteries and fine arteries.

4. The method as set forth in claim 2, wherein said other fluid flow channels comprise neural fluid flow channels.

5. The method as set forth in claim 1, wherein the angular range of motion of said longitudinal axis of said bed, and said person, about said pivot axis is between 10° and 60°.

6. The method as set forth in claim 5, wherein the selected angular range of motion of said longitudinal axis of between 10° and 60° extends symmetrically to either side of a nominally centered horizontal position.

7. The method as set forth in claim 5, wherein said longitudinal axis of said bed, and said person, are moved through an angular range of motion of about 30°.

8. The method as set forth in claim 7, wherein the selected angular range of motion of about 30° extends symmetrically to either side of a nominally centered horizontal position.

9. The method as set forth in claim 1, wherein the cyclical rate utilized for rotatably and cyclically moving said longitudinal axis of said bed, and said person, about said pivot axis is between two cycles per minute and ten cycles per minute.

10. The method as set forth in claim 9, wherein the cyclical rate utilized for rotatably and cyclically moving said longitudinal axis of said bed, and said person, about said pivot axis is about six cycles per minute.

11. The method as set forth in claim 1, wherein the product of the angular range of motion of said longitudinal axis of said bed and the cyclical rate utilized for rotatably and cyclically moving said longitudinal axis of said bed is between 120° cycles/minute and 240° cycles/minute.

12. The method as set forth in claim 11, wherein the product of the angular range of motion of said longitudinal axis of said bed and the cyclical rate utilized for rotatably and cyclically moving said longitudinal axis of said bed is about 180° cycles/minute.

13. The method as set forth in claim 1, further including said drive mechanism being selected from the group comprising a Scotch yoke mechanism, a crank and connecting rod mechanism, a linear drive mechanism, and a hydraulic drive mechanism.

14. The method as set forth in claim 13, wherein said drive mechanism includes said crank and connecting rod mechanism.

15. The method as set forth in claim 1, wherein said bed is configured such that when said longitudinal axis of said bed is disposed in a centered position, the torso and head supporting portion thereof is angled upwards with reference to said longitudinal axis at an angle approximately equal to half of the selected angular range while the thigh supporting portion thereof is oppositely angled upwards with reference to said longitudinal axis at an angle approximately equal to the selected angular range, and the calf and foot supporting portion thereof is disposed in a plane nominally parallel to said longitudinal axis.

16. The method as set forth in claim 1, wherein the disease or ailment condition is heart disease, or other forms of cardiovascular disease.

17. The method as set forth in claim 1, wherein the disease or ailment condition is Parkinson's disease.

18. The method as set forth in claim 1, wherein the disease or ailment condition is Alzheimer's disease.

19. (canceled)

20. The method as set forth in claim 1, wherein the disease or ailment condition is essential tremor.

21. The method as set forth in claim 1, wherein the disease or ailment condition is muscular dystrophy.

22. The method as set forth in claim 1, wherein the disease or ailment condition is autism.

23. The method as set forth in claim 1, wherein the disease or ailment condition is migraine headaches.

24. The method as set forth in claim 1, wherein the disease or ailment condition is brain injuries.

25. The method as set forth in claim 1, wherein the disease or ailment condition is diabetic circulation problems.

26. The method as set forth in claim 1, wherein the method additionally comprises the steps of:
locating the BPM apparatus in a relatively isolated and quite environment; and
maintaining a comfortable and relaxed state of the person.

27. The method as set forth in claim 26, wherein maintaining the comfortable and relaxed state of the person comprises avoiding any contact with the person (i.e., such as talking to him or her) for the purpose of inducing him or her into a state of sleeping.

28. The method as set forth in claim 26, wherein maintaining the comfortable and relaxed state of the person comprises engaging in quiet and relaxing conversation with a person for the purpose of calming him or her if he or she exhibits hyperactivity, hypersensitivity or hyperirritability symptoms.

29. A method for the treatment of a disease or ailment condition through the use of blood pressure modulation (BPM) therapy, said method comprising the steps of: providing a BPM apparatus comprising:
a bed configured to retain a person thereupon in a supine manner generally along a longitudinal axis such that said person's upper torso and head are longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said BPM apparatus further including a controller;
said BPM apparatus further including a servomotor that is operatively connected to and driven by a power signal issued from said controller;
a drive mechanism for selectively coupling to said servomotor to said bed; and
said BPM apparatus further including position measuring apparatus operatively connected to said bed and said controller, said position measuring apparatus issuing a position signal indicative of rotational positions of said longitudinal axis to said controller;
wherein said servomotor is energizable by said controller operating in a closed-loop manner via issuing a controlled power signal to said servomotor such that said position signal can be maintained in close conformance with a command signal representative of a selected program for rotatably and cyclically moving said bed about said pivot axis;
disposing a person on said bed so that said person lies supinely thereupon with his or her upper torso and head, and lower extremities spaced apart generally along said longitudinal axis; and
energizing said servomotor with said controller in accordance with said command signal so as to activate said BPM apparatus and thereby rotatably move said bed about said pivot axis through at least one cycle wherein said person's upper torso and head are raised to a level higher than said person's lower extremities, and vice-versa;
wherein said at least one cycle causes a modulation of the person's venous blood pressure wherein resulting venous blood pressure switching events cause shrinking and swelling of the veins of the person's upper torso and head, and concomitantly, swelling and shrinking of the veins of the person's lower extremities.

30. The method as set forth in claim 29, further including said drive mechanism being selected from the group comprising a linear drive mechanism and a hydraulic drive mechanism.

31. The method as set forth in claim 29, wherein said command signal is configured in accordance with the method additionally comprising the steps of:
prior to initiating a treatment session, returning said bed to its full upper torso and head-elevated position;
after the person has been positioned in a supine position upon the bed, executing a “jog” command signifying that said person has been properly placed on said bed;
smoothly accelerating said bed toward the horizontal position such that it reaches a maximum cyclical speed value concomitantly with reaching the horizontal position;
executing a cyclical motion symmetrically about said horizontal position in accordance with selected angular range and cyclical rate values for the duration of the treatment session;
smoothly decelerating said bed to zero speed at its full upper torso and head-elevated position, beginning with a final crossing of said bed through the horizontal position as it moves toward the upper torso and head-elevated position; and
removing said person from said bed in order to terminate said treatment session.

32. A blood pressure modulation (BPM) apparatus for use by a supinely disposed person for implementing BPM motions of his or her entire body, comprising:
a bed configured to retain a person thereupon generally along a longitudinal axis in a supine manner such that said person's upper torso and head are longitudinally spaced apart from said person's lower extremities;
said BPM apparatus further including a supporting frame for pivotingly supporting said bed about a transversely disposed pivot axis nominally orthogonal to a vertical plane comprising said longitudinal axis, said longitudinal axis of said bed then being operative for defining instant rotational orientations of said bed around said pivot axis;
said BPM apparatus further including a motor; and
a drive mechanism for selectively coupling said motor to said bed;
wherein said motor is energizable for rotatably and cyclically moving said bed and said person's whole body about said pivot axis in a controlled cyclical manner

33. The BPM apparatus as set forth in claim 32, wherein the angular range of motion of said longitudinal axis of said bed, and said person, about said pivot axis is between 10° and 60°.

34. The BPM apparatus as set forth in claim 33, wherein the selected angular range of motion of said longitudinal axis of between 10° and 60° extends symmetrically to either side of a nominally centered horizontal position.

35. The BPM apparatus as set forth in claim 33, wherein said longitudinal axis of said bed, and said person, are moved through an angular range of motion of about 30°.

36. The BPM apparatus as set forth in claim 35, wherein the selected angular range of motion of about 30° extends symmetrically to either side of a nominally centered horizontal position.

37. The BPM apparatus as set forth in claim 35, wherein the combination of said motor and said drive mechanism is chosen such that the resulting cyclical rate utilized for rotatably and cyclically moving said longitudinal axis of said bed, and said person, about said pivot axis is between two cycles per minute and ten cycles per minute.

38. The BPM apparatus as set forth in claim 37, wherein the combination of said motor and said drive mechanism is chosen such that the resulting cyclical rate utilized for rotatably and cyclically moving said longitudinal axis of said bed, and said person, about said pivot axis is about six cycles per minute.

39. The method as set forth in claim 33, wherein the product of the angular range of motion of said longitudinal axis of said bed and the cyclical rate utilized for rotatably and cyclically moving said longitudinal axis of said bed is between 120° cycles/minute and 240° cycles/minute.

40. The method as set forth in claim 33, wherein the product of the angular range of motion of said longitudinal axis of said bed and the cyclical rate utilized for rotatably and cyclically moving said longitudinal axis of said bed is about 180° cycles/minute.

41. The BPM apparatus as set forth in claim 32, further including said drive mechanism being selected from the group comprising a Scotch yoke mechanism, a crank and connecting rod mechanism, a linear drive mechanism, and a hydraulic drive mechanism.

42. The BPM apparatus as set forth in claim 39, wherein said drive mechanism includes said crank and connecting rod mechanism.

43. The BPM apparatus as set forth in claim 32, wherein said bed is configured such that when said longitudinal axis of said bed is disposed in a centered position, the torso and head supporting portion thereof is angled upwards with reference to said longitudinal axis at an angle approximately equal to half of the selected angular range while the thigh supporting portion thereof is oppositely angled upwards with reference to said longitudinal axis at an angle approximately equal to the selected angular range, and the calf and foot supporting portion thereof is disposed in a plane nominally parallel to said longitudinal axis.
